(19) United States
(12) Patent Application Publication
(10) Pub. No.: US 2018/0309937 A1
(43) Pub. Date: Oct. 25, 2018

(54) DISPLAY DEVICE, DISPLAY METHOD, AND DISPLAY PROGRAM

(71) Applicant: NIKON CORPORATION, Tokyo (JP)

(72) Inventors: Kaoru YOSHINO, Tokyo (JP); Yuki KATSUMATA, Kawasaki-shi (JP); Takashi KURIYAMA, Yokohama-shi (JP); Yoshiaki MIYAKAWA, Tokyo (JP)

(73) Assignee: NIKON CORPORATION, Tokyo (JP)

(21) Appl. No.: 15/779,324

(22) PCT Filed: Nov. 30, 2016
(86) PCT No.: PCT/JP2016/085618

§ 371 Date: May 25, 2018

(30) Foreign Application Priority Data
Nov. 30, 2015 (JP) 2015-234195

(51) Int. Cl. H04N 5/262; H04N 5/445; G06T 7/20; H04N 5/60; G06K 9/46; G06K 9/00

(52) U.S. Cl. CPC H04N 5/2628; H04N 5/44591; G06T 7/20; H04N 5/4403; G06K 9/4661; G06K 9/00744; G06T 2207/10016; H04N 5/602

(57) ABSTRACT

A display device includes: a display unit at which an image is displayed; and a control unit that displays an image in a specific area at the display unit and adjusts the specific area based upon information pertaining to the image.

### TECHNICAL FIELD

The present invention relates to a display device, a display method, and a display program.

### BACKGROUND ART

There are image display systems known in the related art that allow a plurality of images to be brought up on display in a single screen by partitioning the screen into a plurality of screen areas and laying out the plurality of images in the plurality of screen areas (see, for instance, PTL 1). However, there is an issue to be addressed in the related art in that a complicated operation needs to be performed in order to adjust the layout.

### CITATION LIST

### Patent Literature

PTL 1: Japanese Laid Open Patent Publication No. 2010-278824

### SUMMARY OF INVENTION

According to the 1st aspect, a display device comprises: a display unit at which an image is displayed; and a control unit that displays an image in a specific area at the display unit and adjusts the specific area based upon information pertaining to the image.

According to the 2nd aspect, a display program enables a computer to execute: a display step in which an image is displayed at a display screen; and a control step in which an image is displayed in a specific area at the display screen and the specific area is adjusted based upon information pertaining to the image.

According to the 3rd aspect, a display method comprises: a display step in which an image is displayed at a display screen; and a control step in which an image is displayed in a specific area at the display screen and the specific area is adjusted based upon information pertaining to the image.

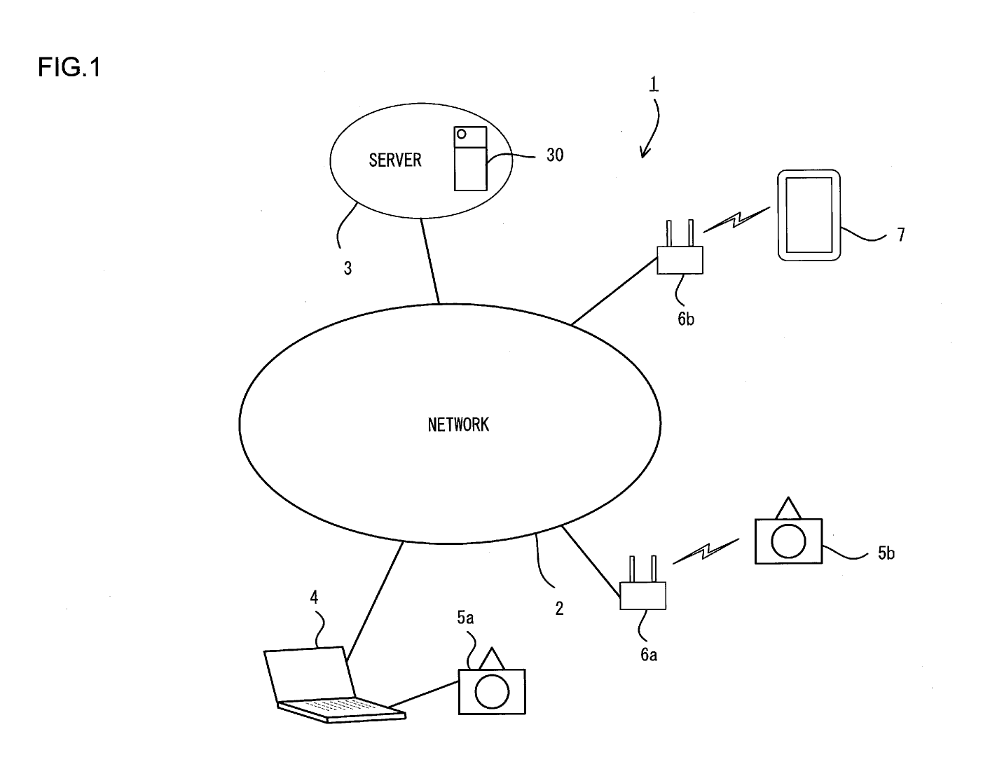

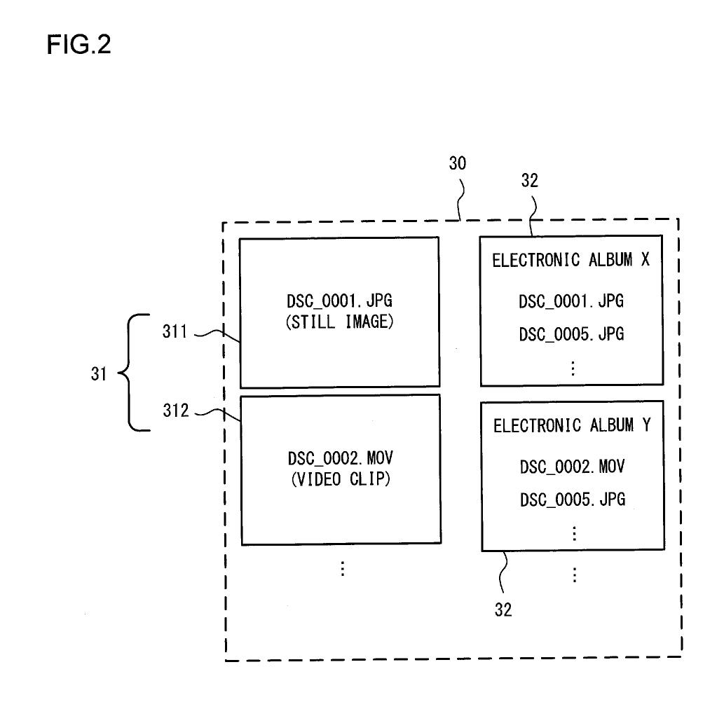

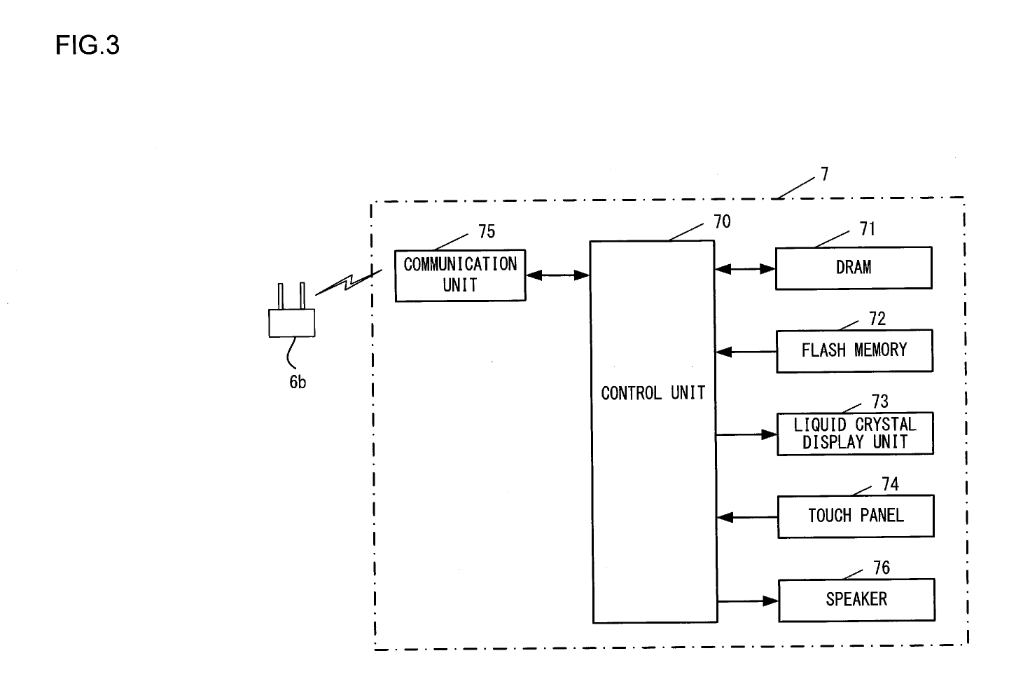

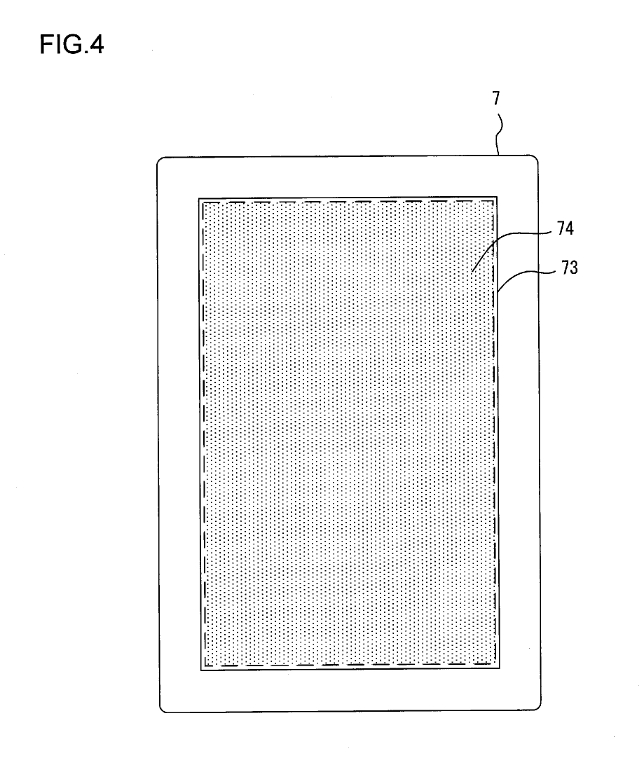

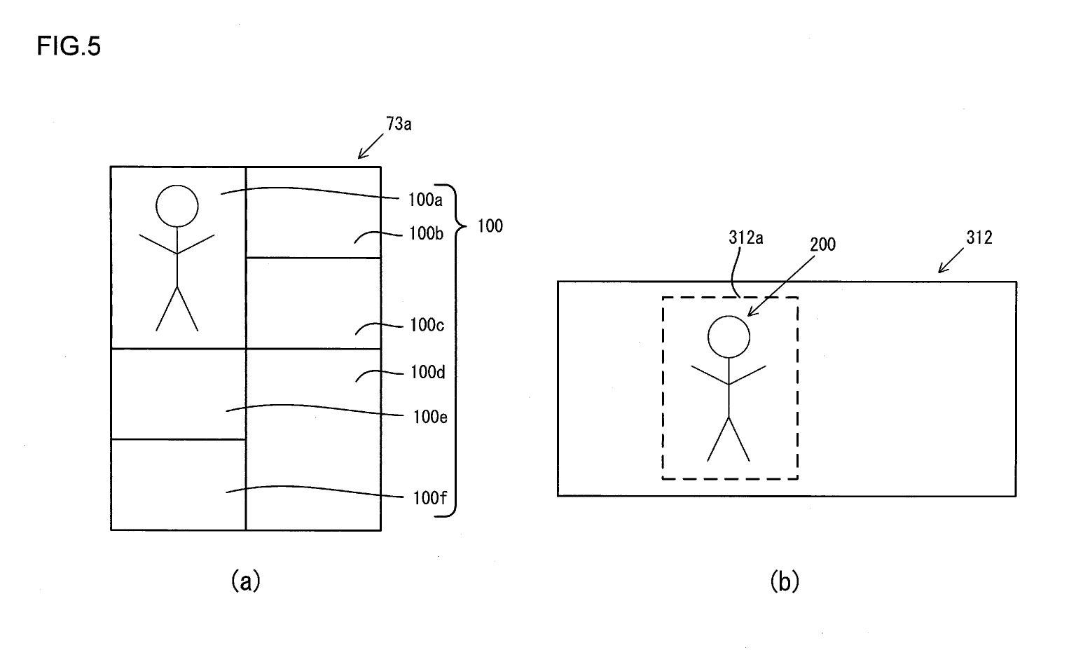

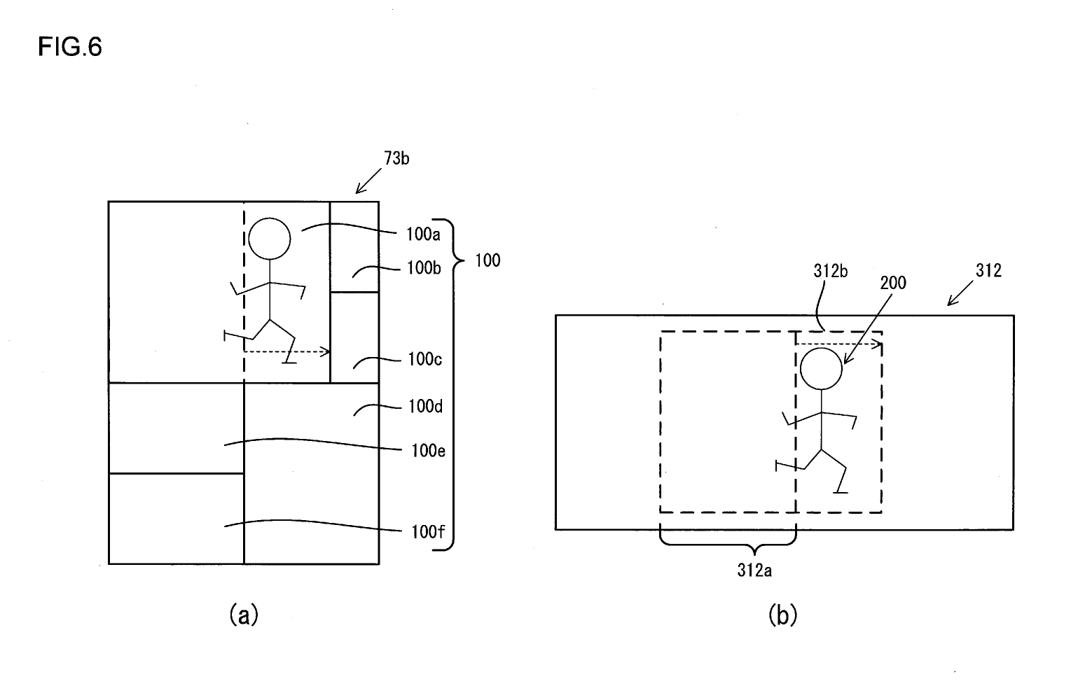

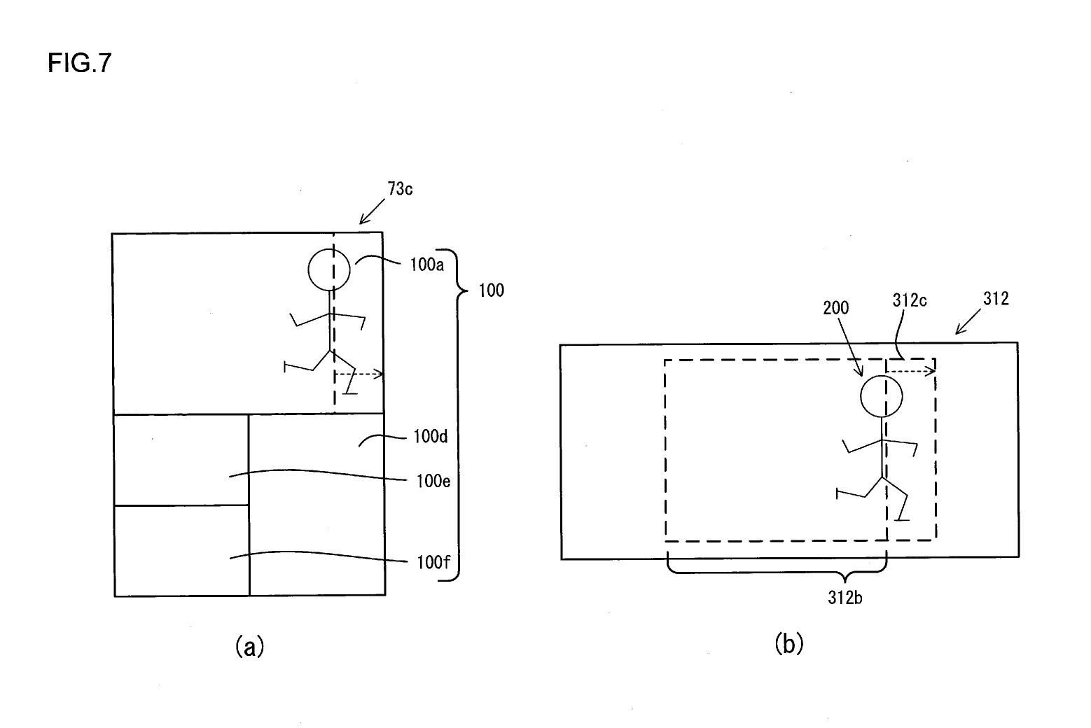

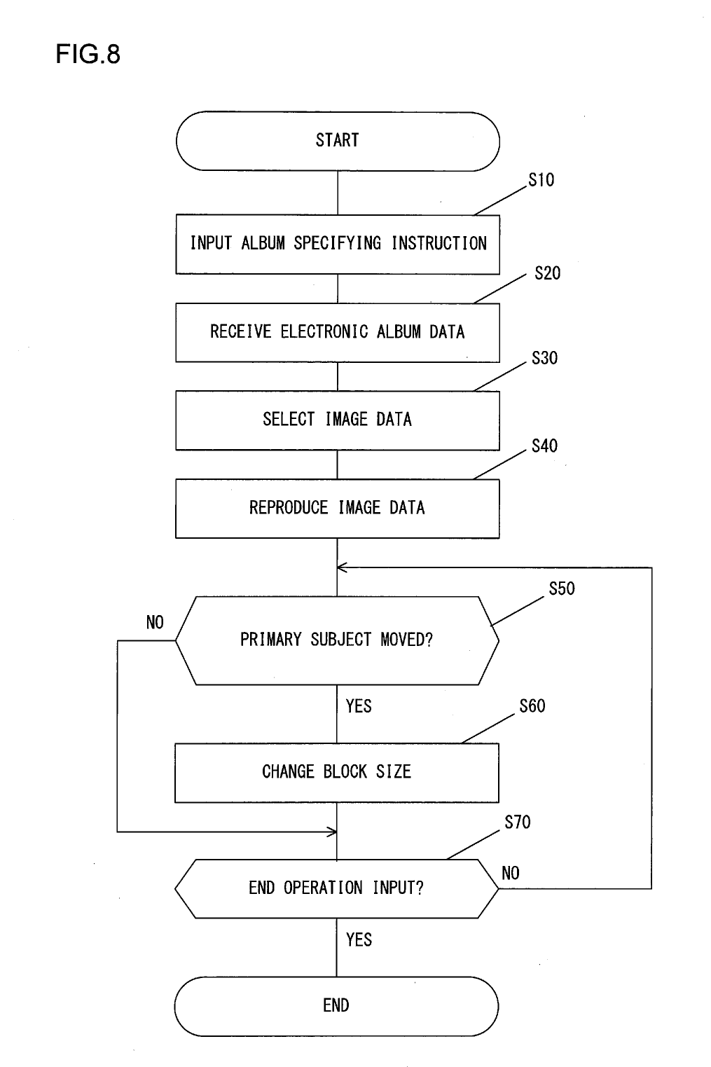

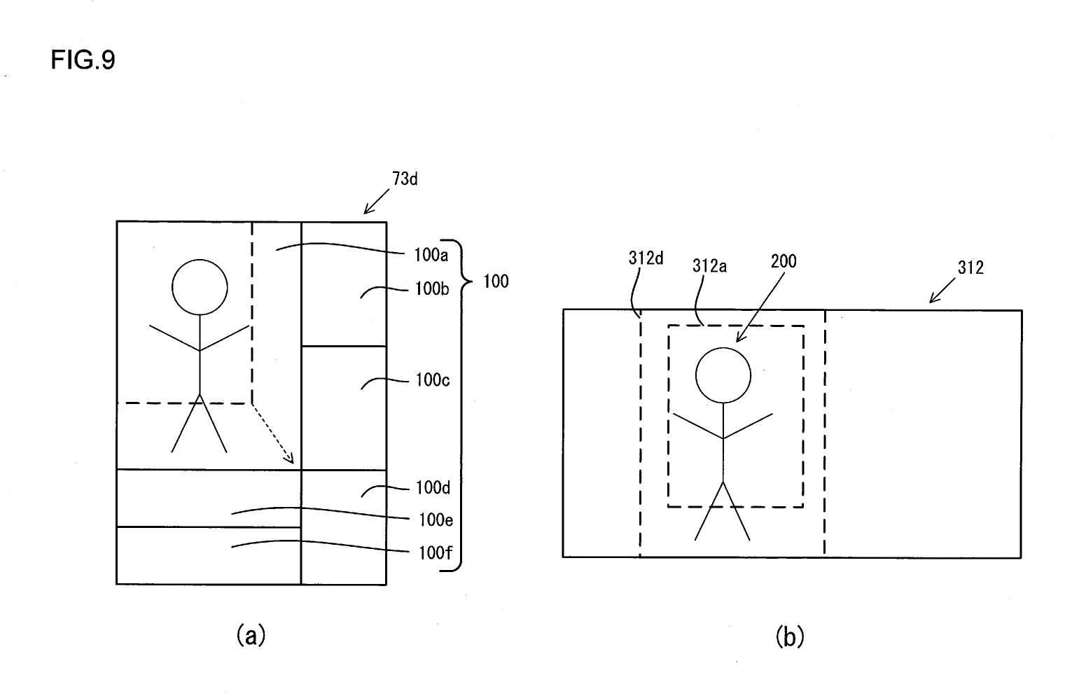

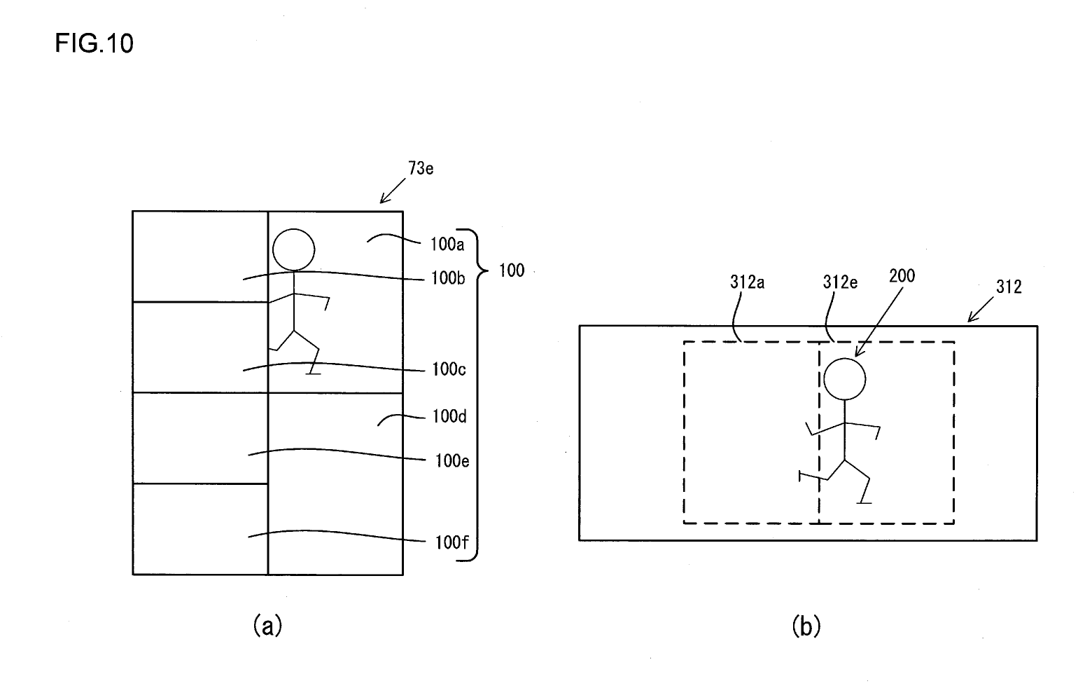

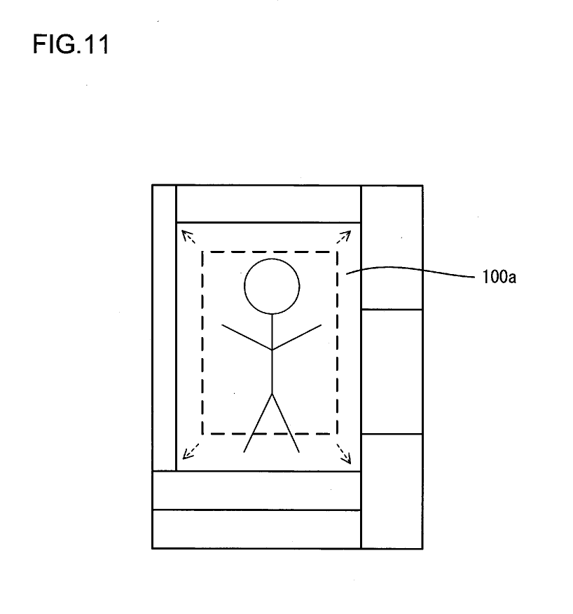

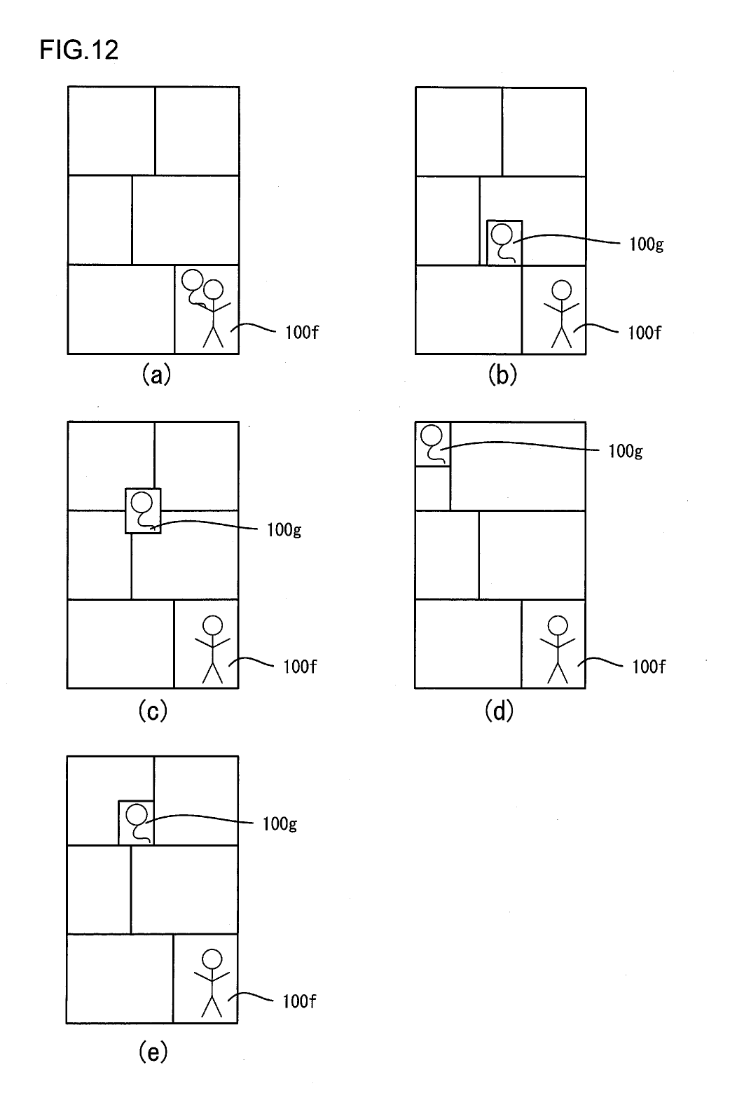

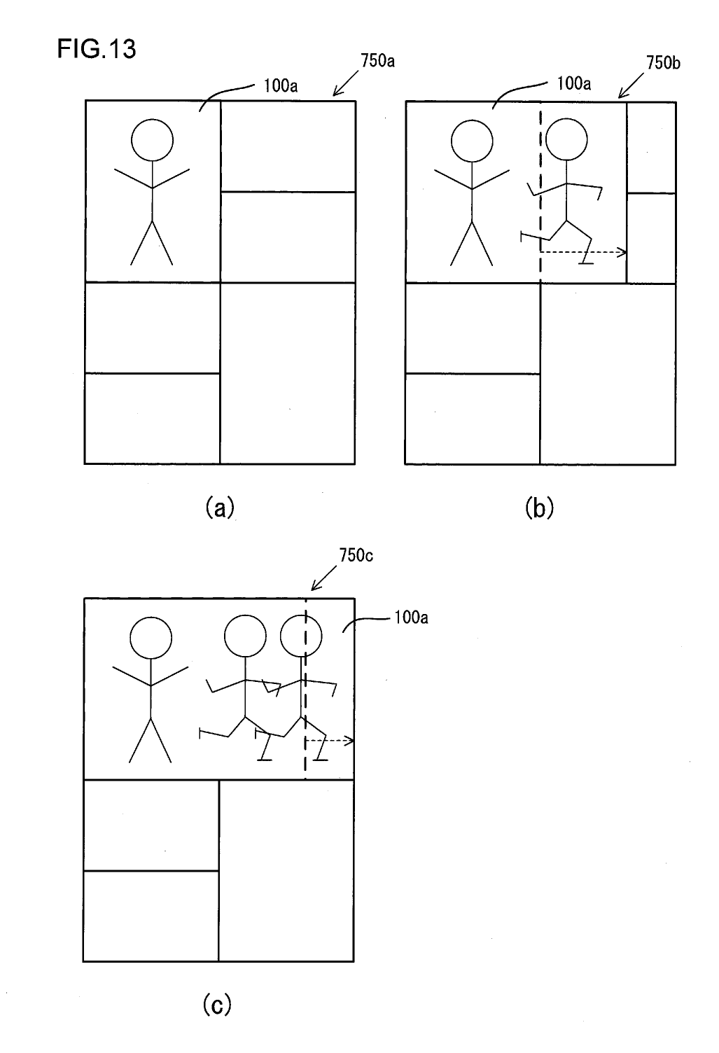

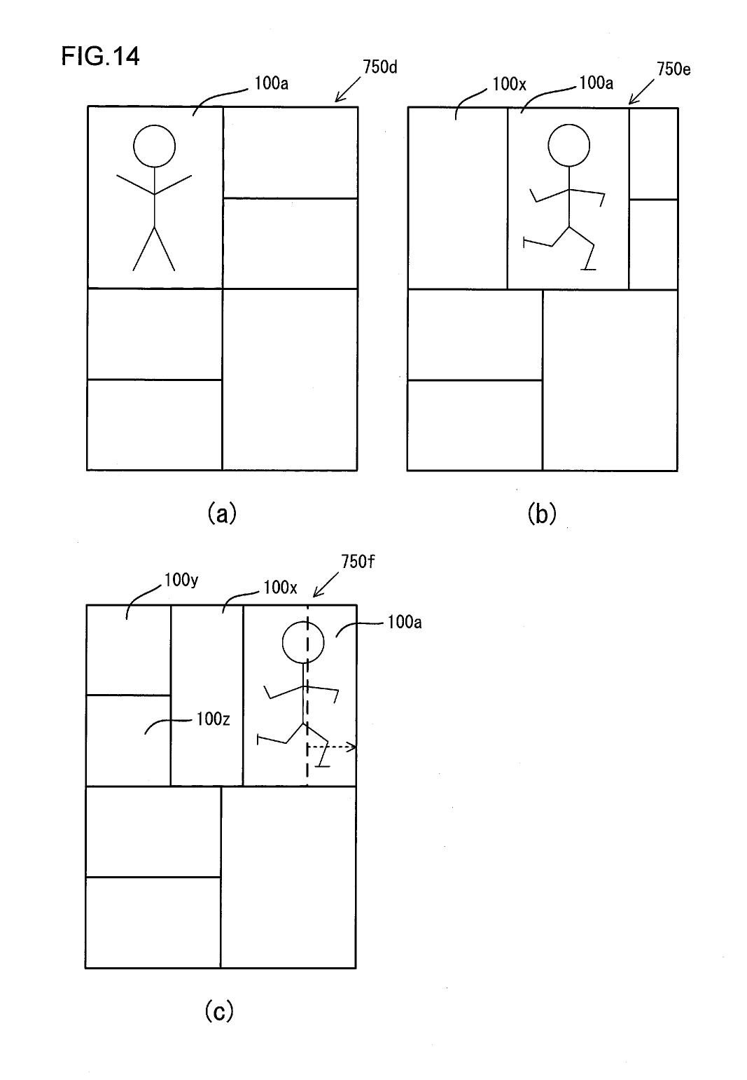

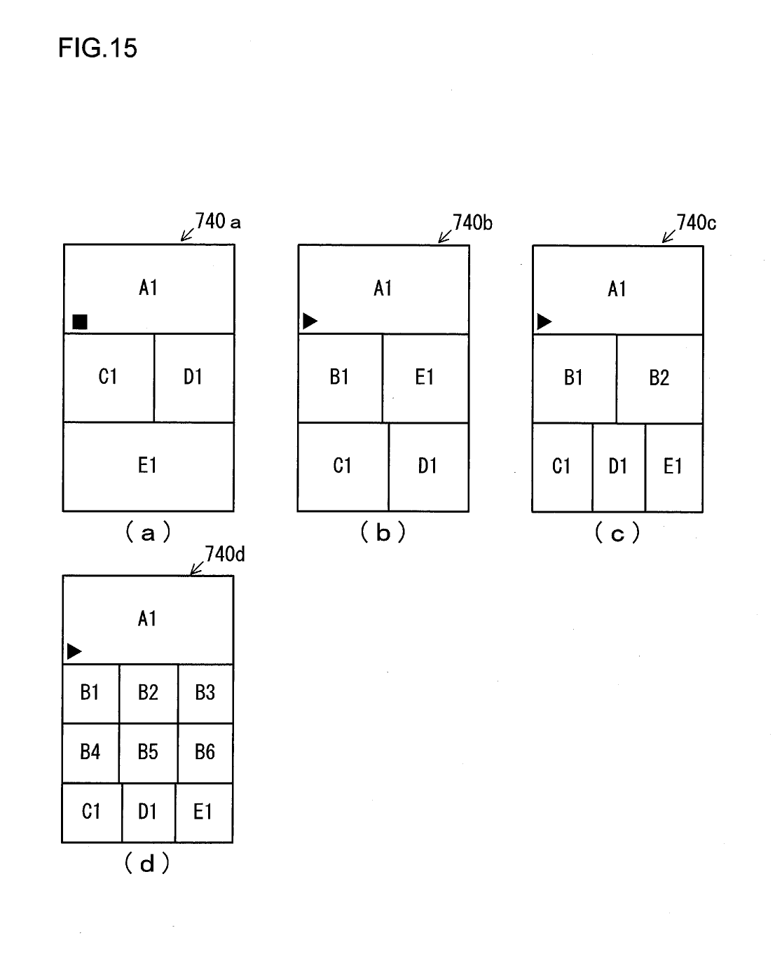

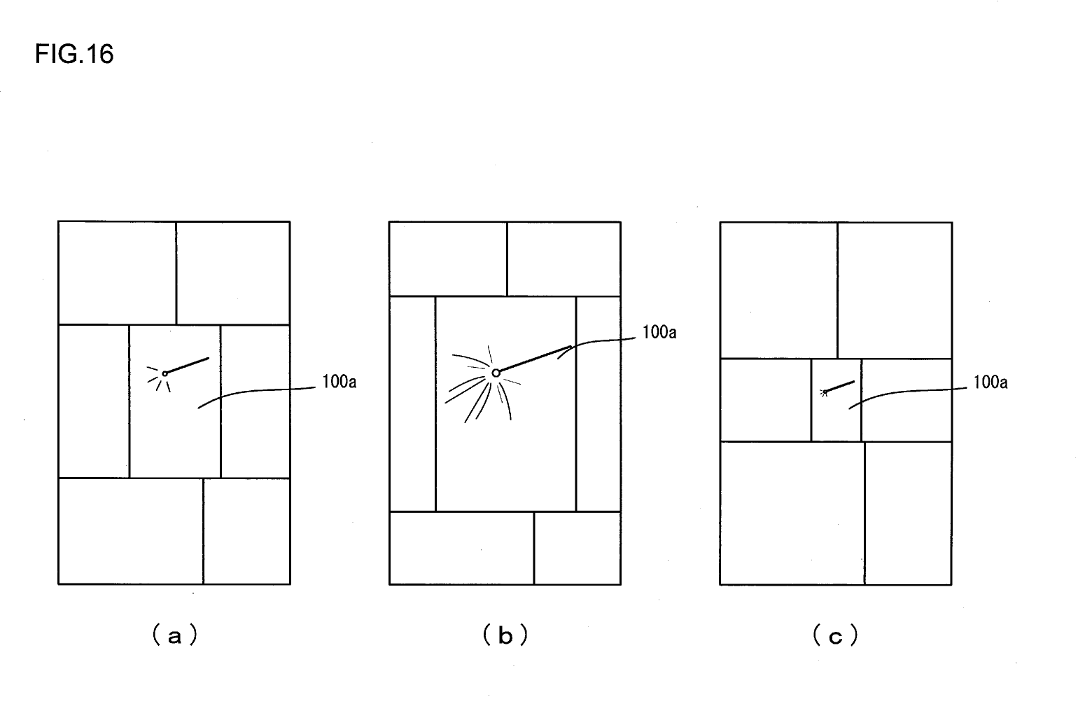

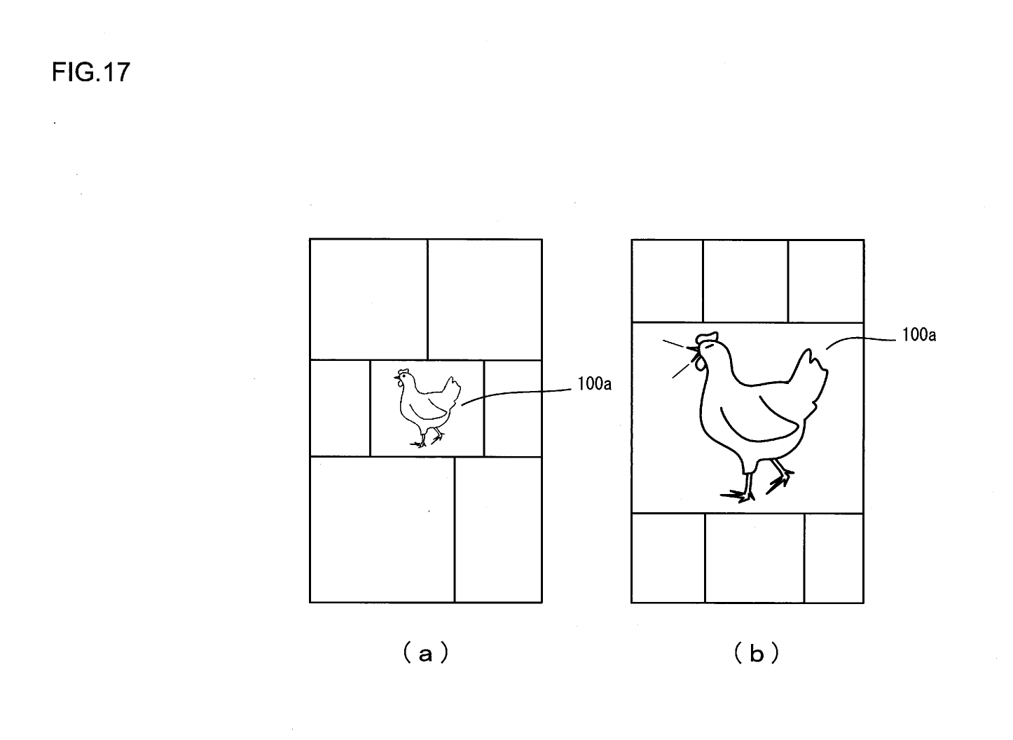

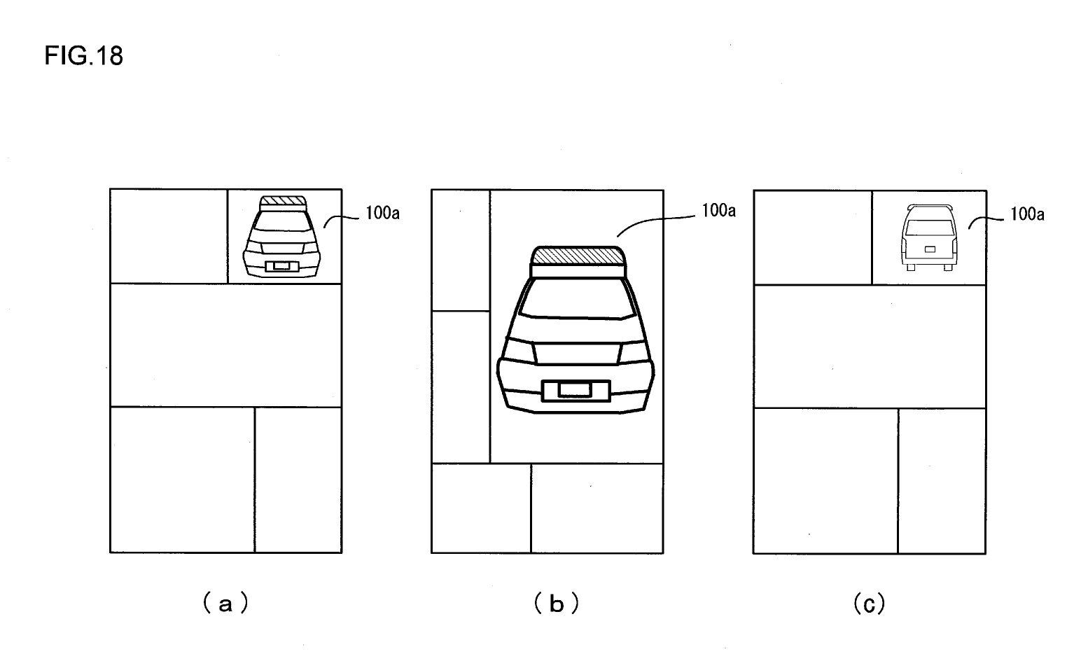

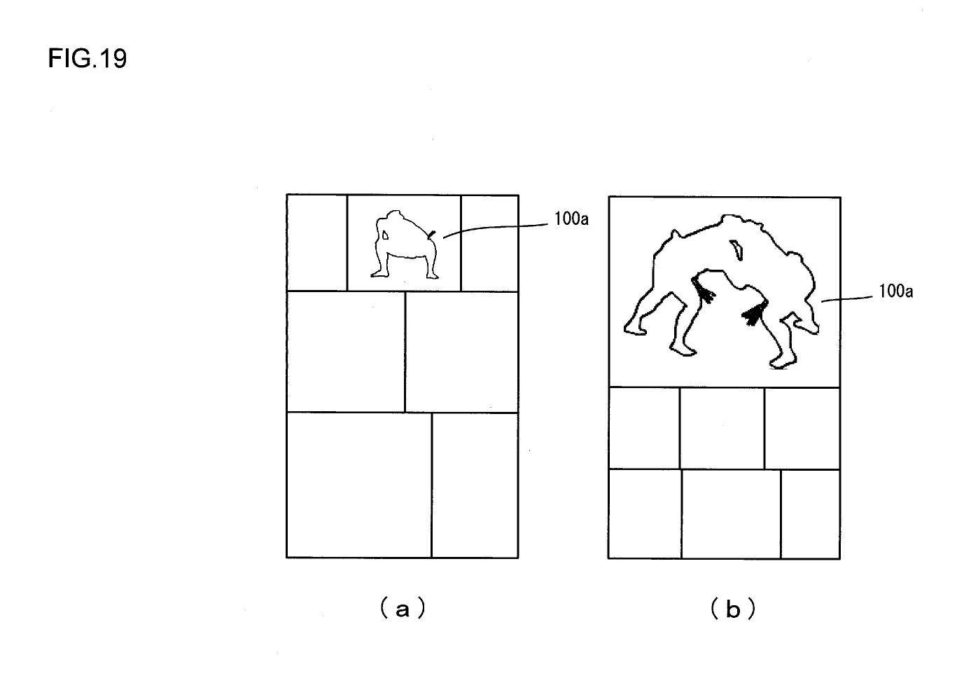

### BRIEF DESCRIPTION OF DRAWINGS

[FIG. 1] A block diagram illustrating the configuration of the image reproduction system achieved in a first embodiment

[FIG. 2] A schematic diagram illustrating data stored in the storage device 30

[FIG. 3] A schematic block diagram illustrating the structure of the portable device 7

[FIG. 4] A schematic diagram illustrating the external appearance of the portable device 7

[FIG. 5] Examples of a display screen and video image data 312 that may be brought up during electronic album reproduction

[FIG. 6] Examples of a display screen and video image data 312 that may be brought up during electronic album reproduction

[FIG. 7] Examples of a display screen and video image data 312 that may be brought up during electronic album reproduction

[FIG. 8] A flowchart of reproduction processing

[FIG. 9] Examples of display a screen and video image data 312 that may be brought up during electronic album reproduction

[FIG. 10] Examples of display a screen and video image data 312 that may be brought up during electronic album reproduction

[FIG. 11] An example display screen that may be brought up during electronic album reproduction

[FIG. 12] Examples of display screens that may be brought up during electronic album reproduction

[FIG. 13] Examples of display screens that may be brought up during electronic album reproduction

[FIG. 14] Examples of display screens that may be brought up during electronic album reproduction

[FIG. 15] Examples of display screens that may be brought up during electronic album reproduction

[FIG. 16] Examples of display screens that may be brought up during electronic album reproduction

[FIG. 17] Examples of display screens that may be brought up during electronic album reproduction

[FIG. 18] Examples of display screens that may be brought up during electronic album reproduction

[FIG. 19] Examples of display screens that may be brought up during electronic album reproduction

### DESCRIPTION OF EMBODIMENTS

### First Embodiment

FIG. 1 is a block diagram illustrating the configuration of the image reproduction system achieved in the first embodiment. An image reproduction system 1 is configured with a network 2, a server 3, an information terminal 4, a camera 5a, a camera 5b, a wireless relay station 6a, a wireless relay station 6b and a portable device 7. It is to be noted that the camera 5a and the camera 5b may each be generically referred to as a camera 5 in the following description.

The image reproduction system 1 allows a photographic image captured with a camera 5 to be reproduced on the portable device 7. The network 2 is a wide-area network such as the Internet. The server 3, the information terminal 4, the wireless relay station 6a and the wireless relay station 6b are connected to the network 2. The information terminal 4 may be, for instance, a personal computer. Image data can be transmitted from the camera 5a to the server 3 via the information terminal 4 and the network 2.

The wireless relay station 6a and the wireless relay station 6b are engaged in wireless communication via means such as a wireless LAN, with the camera 5b and the portable device 7 respectively. Image data can be transmitted from the camera 5b to the server 3 via the wireless relay station 6a and the network 2. Image data from the server 3 can be received at the portable device 7 via the wireless relay station 6b and the network 2.

The server 3 includes a storage device 30. The storage device 30 may be constituted with, for instance, an HDD. At the server 3, image data received from the camera 5a and the camera 5b are stored into the storage device 30. The server 3 transmits various types of data stored in the storage device 30 to the portable device 7 as needed.

FIG. 2 schematically illustrates data stored in the storage device 30. A plurality of sets of image data 31 and a plurality of sets of electronic album data 32 are stored in the storage device 30. The image data 31 include still image data 311 having still images recorded therein and video image data (motion picture data or movie data) 312 with video (motion picture or movie) clips recorded therein. The still image data 311 are stored as image files created in a camera 5 in, for instance, the JPEG format. The video image data 312 are stored as image files created in a camera 5 in, for instance, the motion JPEG format. A set of video image data 312 includes subject image information (image signals) recorded in time sequence and audio information (audio signals) recorded in time sequence. It is to be noted that the video image data 312 do not need to include audio information.

A set of electronic album data 32 expresses an electronic album. A plurality of sets of image data 31 are correlated to a set of electronic album data 32. The user is able to create and edit electronic album data 32 by, for instance, operating the information terminal 4. The user selects a plurality of sets of image data 31 and creates a set of electronic album data 32 to which the selected image data 31 are correlated. In the following description, image data 31 correlated to a set of electronic album data 32 will be referred to as image data 31 included in the particular set of electronic album data 32.

FIG. 3 is a block diagram schematically illustrating the structure of the portable device 7. The portable device 7 is an information terminal widely referred to as a tablet-type terminal. The portable device 7 includes a control unit 70, a DRAM 71, a flash memory 72, a liquid crystal display unit 73, a touch panel 74, a communication unit 75 and a speaker 76.

The control unit 70 is configured with a microprocessor and its peripheral circuits (not shown). The control unit 70 controls the various components of the portable device 7 by executing a specific control program read from the flash memory 72 where the control program is recorded in advance. The DRAM 71 is the main storage device, whereas the flash memory 72 is an auxiliary storage device. The liquid crystal display unit 73 is a display device. The touch panel 74 is an input device laminated upon the liquid crystal display unit 73. The communication unit 75 is a communication module engaged in wireless data communication with the wireless relay station 6b. The control unit 70 is able to carry out data communication with a node such as the server 3 connected to the network 2, via the communication unit 75. The speaker 76 is used when playing back audio data (audio signals) included in the video image data 312.

FIG. 4 schematically illustrates the external appearance of the portable device 7. The portable device 7 includes a casing that takes the form of a plate. The liquid crystal display unit 73 is disposed at one surface of the casing. The touch panel 74 is laminated upon the liquid crystal display unit 73. As the user touches the display screen of the liquid crystal display unit 73 with his finger or the like, the touch panel 74 detects the contact position at the display screen. In the following description, various types of operations performed by the user by touching the display screen of the liquid crystal display unit 73 with his finger or the like will be referred to as touch operations.

The portable device 7 is capable of reproducing an electronic album based upon electronic album data 32 stored in the storage device 30. The reproduction processing executed to reproduce an electronic album will be explained next.

FIG. 5(a) presents an example of a display screen 73a that may come up for electronic album reproduction. The display screen 73a in FIG. 5(a) is partitioned in a tile pattern into a first block 100a, a second block 100b, a third block 100c, a fourth block 100d, a fifth block 100e and a sixth block 100f. In the following description, individual blocks such as the first block 100a, the second block 100b, the third block 100c, the fourth block 100d, the fifth block 100e and the sixth block 100f may each be generically referred to as a block 100. The individual blocks 100 each take a rectangular shape, but their sizes and positions vary. It is to be noted that the blocks do not need to take a rectangular shape and may instead take another shape such as a square shape or a rhomboid shape.

The control unit 70 selects six sets of image data 31 among the sets of image data 31 included in the reproduction-target electronic album data 32 and displays them respectively in the first block 100a, the second block 100b, the third block 100c, the fourth block 100d, the fifth block 100e and the sixth block 100f. If a set of image data 31 having been selected is video image data 312, the control unit 70 selects one frame among the frames of images in the video image data 312 and displays the selected frame alone within the corresponding display block 100. In response to a touch operation performed at the particular block 100 by the user viewing images (hereafter referred to as the viewer), the control unit 70 starts playing back the video image data 312 within the block 100.

It is to be further noted that the sizes and aspect ratios of the sets of image data 31 do not always match the sizes and aspect ratios of the display area blocks 100. The control unit 70 processes the image data 31 as needed so that they can be fitted into the corresponding blocks 100 on display. For instance, the image data 31 to be displayed in the first block 100a may be enlarged or reduced, part of the image data 31 may be cropped or the aspect ratio of the image data 31 may be adjusted by creating a margin around the image data 31.

In addition, the viewer is able to navigate through pages, e.g., move forward or backward to another page, by touching the touch panel 74 or operating an operation member (not shown). In response to a page navigating operation performed by the viewer, the control unit 70 replaces the image data 31 currently displayed in the various blocks 100 with other sets of image data 31.

It is to be noted that it is not strictly necessary to make all the sets of image data 71 included in the electronic album available for viewing in response to a page navigating operation. In addition, sets of image data 31 to be newly brought up on display in response to a page navigating operation may be determined based upon predetermined priority rankings. Such priority rankings may be determined for numerous sets of image data 31 included in an electronic album through an existing image decision-making means such as subject extraction and vertical/horizontal composition.

A method adopted by the control unit 70 when reproducing video image data 312 will be described in specific detail. For instance, a set of video image data 312 such as that shown in FIG. 5(b) may be played back in the first block 100a set in the display screen 73a in FIG. 5(a). The playback-target video image data 312 are represented by the first frame of image in the example presented in FIG. 5(b). The individual frames constituting the video image data 312 assume a size greater than the first block 100a, and accordingly, the control unit 70 crops out part of the first frame, i.e., an area 312a, and displays the area 312a in the first block 100a. The control unit 70 recognizes a primary subject 200 in the video image data 312 through a technology known in the related art such as subject extraction. The control unit 70 determines the partial area 312a, i.e. the part of the frame to be cropped out, by ensuring that the partial area 312a contains the primary subject 200.

The control unit 70 continuously plays back the video image data 312 at the display screen 73a such as that shown in FIG. 5(a). The control unit 70 adjusts the size of the first block 100a in line with movements of the primary subject 200 in the video image data 312 being played back.

FIG. 6(a) presents an example of a display screen 73b that includes the first block 100a with the size thereof having been altered based upon a movement made by the primary subject 200, whereas FIG. 6(b) presents an example of the playback state of the video image data 312 being played back at the time. FIG. 6(b) differs from FIG. 5(b) in that the primary subject 200 has moved toward the right side of the screen in FIG. 6(b). In correspondence to this movement, the control unit 70 enlarges the first block 100a so that the first block 100a expands toward the right side of the screen, as shown in FIG. 6(a). The control unit 70 secures sufficient space for the expanding first block 100a by reducing the lateral dimensions of the second block 100b and the third block 100c located to the right relative to the first block 100a. It is to be noted that the sizes of the second block 100b and the third block 100c may be reduced or portions of the images may be cropped so as to ensure that the primary subjects in the images remain on display in the individual blocks, even as the size of the first block 100a is altered.

The control unit 70 expands the partial area 312a (see FIG. 5(b)) toward the right so as to contain the primary subject in the partial area 312a, as illustrated in FIG. 6(b). The control unit 70 crops out the content of an expanded area 312b and displays the content thus cropped out in the first block 100a, the size of which has been increased. As described above, the partial area 312b is set so that it includes a range further to the right relative to the range contained in the initial area 312a while retaining the range of the area 312a. As a result, the primary subject 200 that has moved can be displayed without altering positions at which of subjects and the like in the background area are displayed.

FIG. 7(a) presents an example of a display screen 73c that includes the first block 100a with the size thereof having been altered based upon a further movement made by the primary subject 200, whereas FIG. 7(b) presents an example of the playback state of the video image data 312 being played back at the time. In line with the further movement to the right made by the primary subject 200, both an area 312c containing the primary subject 200 and the first block 100a range so as to run over the full width of the screen in FIG. 7(a). The second block 100b and the third block 100c are no longer present in the display screen 73c. In other words, as the primary subject 200 continues to move, the control unit 70 adjusts the display mode for the other blocks 100 as well as the display mode for the first block 100a where the video playback is in progress.

It is to be noted that if the primary subject 200 in the state shown in FIG. 7(b) moves to the left, the control unit 70 reduces the size of the first block 100a so that it is compressed toward the left. As a result, the second block 100b and the third block 100c are brought back on display at the screen.

While an explanation has been given on an example in which video playback is executed within the first block 100a alone, the control unit 70 may adopt a structure that allows video clips to be played back simultaneously in a plurality of blocks 100. In such a case, the control unit 70 may adjust the display mode assumed in each block 100 based upon the states of video playback in progress in the individual blocks 100. In other words, the size adjustment operation executed as has been described in reference to FIG. 5 through FIG. 7 to adjust the size of a block in correspondence to the movement made therein by the primary subject 200, may be executed concurrently at a plurality of blocks 100.

In addition, instead of taking the second block 100b and the third block 100c off the display as the size of the first block 100a changes, as shown in FIG. 7(a), the second block 100b and the third block 100c may be kept up on display. Namely, control may be executed so that the second block 100b and the third block 100c do not become smaller than a predetermined size even when the size of the first block 100a changes.

The image displayed in the block 100b is a primary subject image area trimmed out of the overall image. If no primary subject is detected, a central area of the image may be displayed.

FIG. 8 presents a flowchart of the reproduction processing. In step S10, an instruction for identifying electronic album data 32 to be designated as a reproduction target is input to the control unit 70. The viewer enters, via an input device such as the touch panel 74, the title, the URL or the like of a specific electronic album, required for identification of the particular electronic album data 32. In step S20, the control unit 70 receives the reproduction-target electronic album data 32 from the server 3.

In step S30, the control unit 70 selects a plurality of sets of image data 31 to be brought up on display in the display screen, among the sets of image data 31 included in the electronic album data 32. In step S40, the control unit 70 individually reproduces the plurality of sets of image data 31 selected in step S30 in the plurality of blocks 100.

In step S50, the control unit 70 makes a decision as to whether or not the primary subject 200 has moved along a specific direction in the block 100 where video playback is in progress. If the primary subject 200 has not moved, the control unit 70 proceeds to execute the processing in step S70. If, on the other hand, the primary subject 200 has moved along a specific direction, the control unit 70 proceeds to execute the processing in step S60. In step S60, the control unit 70 expands or compresses the block 100, in which the video playback is in progress, in the specific direction along which the primary subject 200 has moved. Subsequently, the control unit 70 proceeds to execute the processing in step S70.

In step S70, the control unit 70 makes a decision as to whether or not a specific reproduction end operation has been performed. If no reproduction end operation has been performed, the control unit 70 proceeds to execute the processing in step S50. If, on the other hand, a reproduction end operation has been performed, the control unit 70 ends the electronic album reproduction processing. It is to be noted that the control unit 70 may end the video playback in step S70 once the video playback has been completed, regardless of whether or not a specific reproduction end operation has been performed. Namely, the video playback may be terminated in response to a viewer operation or it may be terminated without requiring a viewer operation once the video clip has been played back. In addition, when the control unit 70 ends the video playback without requiring a specific reproduction end operation, it may end the playback after the video clip has been played back once or a plurality of times. The viewer may be allowed to set in advance the number of playbacks to occur before the video playback is ended or the number of playbacks to occur before the video playback ends may be controlled in correspondence to a video playback duration (e.g., a setting at which the video is to be played back for five minutes).

It is to be noted that once the video playback ends, the block to which the video is designated may resume the initial display mode that was set before the video playback, or the display mode assumed in the block at the time when the video playback ends may be sustained. The viewer may be allowed to select in advance a setting at which the initial display mode is resumed in the block to which the video is designated at the end of the video playback or a setting at which the display mode at the video playback end is sustained.

It is to be noted that the initial display mode for the block to which the video clip is designated may be adjusted depending upon the content of the video clip being played back. For instance, the video clip in the example described in reference to FIGS. 5 and 6 contains a subject that moves from left to right, and accordingly, the video clip is designated to the first block 100a in a specific position, as shown in FIG. 5. However, a video clip with a subject moving from right to left may be designated to the position corresponding to the block 100d in FIG. 5. In addition, a display mode in which the block to which the video clip is designated is initially displayed in a small (large) size shifts into a display mode in which the block is displayed in a large (small) size as the subject moves in order to enhance the dynamic effect of the moving subject during the video playback. Furthermore, the position of the block to which the video clip is designated may be switched in correspondence to the content of the video being played back, e.g., from the upper side to the lower side in the display screen. For instance, a video clip of a kite being flown may be designated to the block 100f in FIG. 5(a) for playback. In this case, as the video playback progresses (as the main subject, i.e., as the kite, lifts off the ground and soars up to the sky), the block may be expanded into the area that has been taken up by the block 100e thus far and eventually into an area initially taken up by the block 100a. In other words, the video clip may be designated to a block located at the position opposite from the direction in which the primary subject of the video clip moves as the video clip is played back (so as to leave a margin of a display area along the advancing direction).

Moreover, the display screen may be partitioned in a specific pattern for playback of a given video clip. If, on the other hand, the display screen is already partitioned in a predetermined pattern and there is only a limited block to which video clips can be designated, a video clip best suited for the particular block may be displayed.

It is to be noted that once the playback of the first video clip ends, the same video clip may be played back again in response to a viewer operation, or playback of another video clip related to the video clip that has just finished playing may start. During the processing for switching to another video clip related to the first video clip, the display mode for the entire display screen may be adjusted or the display mode for only part of the display screen may be adjusted.

The following advantages and operations are achieved through the embodiment described above.

(1) The control unit 70 plays back video image data 312 in the first block 100a, among a plurality of blocks 100 set in the display screen and reproduces video image data 312 or still image data 311 in each of the other blocks 100. Based upon the state of the playback in progress in the first block 100a, in which the video data 312 are being played back, the control unit 70 adjusts the display mode for the first block 100a. Through these measures, a display device assuring ease of use, at which an optimal screen is brought up on display without requiring a complicated operation, can be provided.

(2) The control unit 70 determines the shape, the position and the size of the first block 100a based upon the playback state pertaining to the video image data 312. As a result, the electronic album can be reproduced in an optimal display mode best suited to the playback state pertaining to the video image data 312.

(3) The control unit 70 also alters the display mode for the second block 100b and the third block 100c as well as the display mode for the first block 100a. As a result, the electronic album can be reproduced in an optimal display mode best suited to the playback state pertaining to the video image data 312.

(4) The control unit 70 alters the display mode for the first block 100a based upon the movement made by the primary subject 200 in the video image data 312 being played back in the first block 100a. Thus, a viewing system in which the layout changes in line with the movement made by the primary subject 200 so as to continuously entertain the viewer can be provided.

(5) As the primary subject 200 in the video image data 312 being played back in the first block 100a moves along a specific direction, the control unit 70 expands the first block 100a in the specific direction. Through these measures, the viewer experiences a dynamic visual effect as if the primary subject 200 was causing a change in the layout of the blocks 100.

It is to be noted that while the video playback starts in response to a touch operation performed by the viewer by touching the first block 100a to which the video clip is designated in the example explained above, the timing for the video playback does not need to be linked to a viewer operation and instead the playback may automatically start once the control unit 70 has designated the video clip to the first block 100a and the video clip has been brought up on display in the first block 100a.

### Second Embodiment

The video reproduction system achieved in the second embodiment determines the display mode for the blocks 100 based upon a movement made by the primary subject 200 along the depth-wise direction, as well as movements made by the primary subject 200 along the vertical direction and the horizontal direction, as has been described in reference to the first embodiment. The following is an explanation of features distinguishing the image reproduction system achieved in the second embodiment from the image reproduction system achieved in the first embodiment, given in reference to FIG. 9. It is to be noted that components identical to those in the first embodiment are assigned with the same reference signs so as to preclude the necessity for a repeated explanation thereof.

FIG. 9(a) presents an example of a display screen 73d that includes the first block 100a with the size thereof having been altered based upon a movement made by the primary subject 200, whereas FIG. 9(b) presents an example of the playback state of the video image data 312 being played back at the time. FIG. 9(b) differs from FIG. 5(b) in that as the primary subject 200 has moved further toward the viewer, i.e., as the main subject 200 has moved closer to the camera shooting the video, the size of the primary subject 200 has become larger relative to the screen size in FIG. 9(b). In line with this movement, the control unit 70 expands the first block 100a, as shown in FIG. 9(a). Since the first block 100a is located at the upper left corner of the display screen 73d, the first block 100a only has room to expand to the right and toward the bottom in the display screen 73d. Accordingly, the control unit 70 expands the first block 100a rightward and downward. The control unit 70 secures sufficient space to accommodate the expanding first block 100a by reducing the sizes of the other blocks, i.e., the second block 100b, the third block 100c, the fourth block 100d, the fifth block 100e and the sixth block 100f. It is to be noted that the ratio of the change in the size of the primary subject 200 and the change in the size of the first block 100a can be selected freely.

If, on the other hand, the primary subject has moved further away from the viewer, the size of the primary subject 200 becomes smaller relative to the screen size. In line with this movement, the control unit 70 compresses the first block 100a. The control unit 70 fills the space created by compressing the first block 100a with the other blocks, i.e., the second block 100b, the third block 100c, the fourth block 100d, the fifth block 100e and the sixth block 100f assuming greater sizes.

It is to be noted that the size of the primary subject 200 may change even when the primary subject 200 has not moved. For instance, the camera capturing the image of the primary subject 200 may move forward or backward, resulting in a change in the size of the primary subject 200. Under such circumstances, too, the control unit 70 adjusts the size of the first block 100a. The control unit 70 likewise adjusts the size of the first block 100a if the zoom ratio of the camera capturing the image of the primary subject changes.

It is to be noted that the direction along which the size of the first block 100a is increased, is not limited to the rightward/downward direction, i.e., toward the right side and the bottom side of the screen, as illustrated in FIG. 9(a). For instance, if the first block 100a takes a position at the center of the display screen, as in the example presented in FIG. 11, the first block 100a may be expanded along all the directions (upward, downward, leftward and rightward) in the screen. In such a case, blocks set around the first block 100a will be compressed or removed as needed.

In addition to advantages and operations similar to those achieved in the first embodiment, a further advantage and operation described below is achieved through the embodiment.

(6) As the size of the primary subject 200 in the video image data 312 being played back in the first block 100a changes, the control unit 70 adjusts the size of the first block 100a. As a result, the viewer is able to perceive the movement made by the primary subject 200 in a more direct way.

The following variations are also within the scope of the present invention and one of or a plurality of the variations may be adopted in combination with either of the embodiments described above.

(Variation 1)

While the size of the first block 100a is adjusted in line with the movement made by the primary subject 200 in the embodiments described above, the present invention is not limited to this example. FIG. 10(a) presents an example in which the position of the first block 100a, instead of the size of the first block 100a, is adjusted. As the playback state of the video image data 312 shifts from that illustrated in FIG. 5(b) to the state shown in FIG. 10(b) i.e., as the primary subject 200 moves to the right, the control unit 70 also moves the area 312a in line with the movement made by the primary subject 200 and sets a new area 312d. In response to the rightward movement made by the primary subject 200, the control unit 70 moves the first block 100a toward the right side of a display screen 73e, as illustrated in FIG. 10(a). At the same time, the control unit 70 relocates the second area 100b and the third block 100c, initially set at positions to the right relative to the first block 100a, to positions further leftward relative to the first block 100a. As a result, the position of the first block 100a is switched so that it takes up the area initially occupied by the second block 100b and the third block 100c, and the positions of the second block 100b and the third block 100c are switched so that they take up the area initially occupied by the first block 100a, as illustrated in FIG. 10(a).

In addition, the control unit 70 may sequentially switch to blocks 100 set at different positions for video playback based upon the content of the video image data 312 being played back, i.e., in line with the movement made by the primary subject 200. An example of a block switchover in which video playback is switched to one block and then to another block for a video clip of kite flying will be explained in reference to FIG. 10(a). At the start of video playback, the kite is still on the ground and accordingly, the video clip is designated to the block 100f. Subsequently, as the kite lifts off and moves into the air, the playback block is switched from the block 100f to the block 100e. As the kite gains more altitude, the playback block is switched from the block 100e to the block 100d and ultimately, the playback block is switched from the block 100c to the block 100b. In other words, the video playback block may be switched in line with the movement made by the primary subject (the soaring kite in this example) in the video clip being played back. In addition, while the video playback block moves from the bottom toward the top in the example described above, the block to which the video clip is designated may move up/down, left/right, or up/down, left/right.

For instance, a block switchover for a video clip showing a balloon, released by a person, move up into the sky will be explained in reference to FIG. 12. At the start of video playback shown in FIG. 12(a), the person is holding the balloon and the video clip is designated to the block 100f. Subsequently, as the person releases the balloon and it starts floating upward, the balloon moves out of the block 100f. When the balloon is completely outside the block 100f, the control unit 70 adds a new block 100g, which overlaps another block and displays only the balloon, cropped out of the video image data, in the new block 100g, as shown in FIG. 12(b). At this time, the person who initially held the balloon is still displayed in the block 100f, as in FIG. 12(a). It is to be noted that the person may be displayed in the block 100f by cropping his entire image out from the video image data so that the whole body is included in the display of the block 100f or by cropping out only part of his body in the video image data. The position taken by the block 100g in the display screen is linked to the position of the balloon in the video image data. Namely, as the balloon gains height within the angle of view of the video image data, the block 100g is set to higher positions within the display screen. FIG. 12(c) and FIG. 12(d) show how the position of the block 100g changes in sequence. The block 100g can be controlled so as to move along the vertical direction and the lateral direction within the display screen, as described above.

It is to be noted that while the block 100g reaches the upper left corner of the display screen in FIG. 12(d), the block 100g does not reach the upper left corner of the display screen if the angle of view of the video image data being played back is smaller than the size of the display screen, as illustrated in FIG. 12(e). In addition, once the video playback ends, the display screen may be set to the state shown in FIG. 12(d) or FIG. 12(e), or it may be reset to the state assumed at the video playback start shown in FIG. 12(a).

Furthermore, while the size of the block is altered, or the position of the block is switched as the video playback progresses as shown in FIG. 10 in the examples described above, the shape or the position of the block may change in ways other than those described above. For instance, the shape of a block may change from a vertically oriented rectangle to a square or to a horizontally oriented rectangle. Moreover, as the shape of the block changes, its size may also change, or the size of the block alone may change while its shape remains the same (e.g., with the block retaining, for instance, its initial square shape). As an alternative, the position, the shape and the size of the block may all change.

In addition to advantages and operations similar to those achieved in the first embodiment, a further advantage and operation described below is achieved through variation 1.

(7) As the primary subject 200 in the video image data 312 being played back in the first block 100a moves along a specific direction, the control unit 70 moves the position of the first block 100a along the specific direction. These measures make it possible for the viewer to experience a visual effect as if the primary subject 200 were jumping out from the left side of the second block 100b and the third block 100c.

(Variation 2)

While the display mode for the blocks 100 is adjusted based upon the movement made by the primary subject 200 in the embodiments described above, the display mode for the blocks 100 may be adjusted based upon the playback state of the video image data 312 other than the movement made by the primary subject. For instance, the display mode for the first block 100a may be altered based upon the volume of the audio data included in the video image data 312 being played back in the first block 100a. In more specific terms, the control unit 70 expands the first block 100a, as shown in FIG. 9(a), as the volume of the audio data being played back increases. In addition, it compresses the first block 100a as the volume becomes lower.

Furthermore, if the video image data 312 are a video clip shot by changing the image composition through repositioning the subject, the block display mode may be adjusted based upon the composition change. For instance, when shooting a video clip of a wild bird, the user may capture the image of the primary subject, i.e., the wild bird, at a position near the center of the photographic image so that the landscape captured in the video clip changes as the bird flies. When playing back such a video clip, the shape or the size of the block may be adjusted as the landscape changes instead of adjusting the shape or the size of the block in correspondence to the movement made by the primary subject, i.e., the bird. As an alternative, the block may be switched based upon information provided from an acceleration sensor during the shooting operation (e.g., a panning shot or a tilted shot).

In addition to advantages and operations similar to those achieved in the first embodiment, a further advantage and operation described below is achieved through variation 2.

(8) As the audio volume in the video image data 312 being played back in the first block 100a changes, the control unit 70 adjusts the size of the first block 100a. As a result, an enhanced audio/visual experience can be provided for the viewer viewing the electronic album being reproduced. In addition, the shape of the first block 100a, in which the video image data 312 are played back, is adjusted in line with a change in the subject composition in the video image data 312. Thus, the change in the image composition can be more effectively displayed for a better viewing experience.

(Variation 3)

A plurality of sets of video image data 312 may be designated to a single block 100. The control unit 70 plays back a plurality of sets of video image data 312 designated to the block 100 in sequence. Namely, it plays back the plurality of sets of video image data 312 in the block 100 through time-apportioned play.

In addition, instead of playing back the plurality of sets of video image data 312 in their entirety in the single block 100, part of each set of video image data 312 may be extracted and played back. For instance, each of four sets of video image data 312 designated to a single block 100 may be played back over a limited playback time of one minute. Moreover, instead of determining a uniform playback time for the plurality of sets of video image data 312, the playback time for each set of video image data 312 may be determined based upon the movement made by the primary subject 200, as described above. For instance, a set of video image data 312 featuring more dynamic action may be allocated with a longer playback time compared to other sets of video image data 312.

(Variation 4)

In the embodiments described earlier, the portable device 7 is operated by performing touch operations at the touch panel 74. In other words, instructions issued by the viewer are input to the control unit 70 through touch operations performed at the touch panel 74. Instead of such touch operations, the viewer may perform operations at another operation member (e.g., a mechanical switch).

In addition, touch operations may be replaced with predetermined movements of the viewer detected by various types of sensors. For instance, the viewer's line of sight may be detected by an image capturing device and a change in the sight line may be used as an instruction issued by the viewer. As an alternative, a hand gesture made by the viewer may be detected via an infrared sensor or the like and a predetermined hand gesture may be regarded as an instruction. Moreover, the voice of the viewer may be detected through a microphone and a predetermined sound may be regarded an instruction.

(Variation 5)

While the portable device 7 described in reference to the various embodiments above is a tablet terminal, the present invention may be adopted in conjunction with a terminal assuming another mode. For instance, it may be a smart phone, a camera or a personal computer. When the portable device 7 is configured as any of various terminals with varying screen sizes, the number of blocks 100 may be adjusted in correspondence to the screen size of a specific terminal.

(Variation 6)

The operating methods and display methods described above simply represent examples and the present invention may adopt an operating method or display method different from those. For instance, the entire display screen is covered with a plurality of blocks 100 in the embodiments described above. As an alternative, clearances may be provided between the individual blocks 100. Namely, the plurality of blocks 100 do not need to be densely set without any gaps between them over the entire display screen. In another example related to a display method, a display device such as that disclosed in International Publication WO 2013/077338, which displays a 3D image in space, may be used in place of the liquid crystal display unit 73.

(Other Variations)

As the primary subject 200 moves, a past image of the primary subject 200 may also be retained within the block. For instance, the primary subject 200 in a display screen 750a shown in FIG. 13(a) may move toward the right side of the screen as in a display screen 750b in FIG. 13(b) and a display screen 750c in FIG. 13(c). Under such circumstances, the block 100a in which the primary subject 200 is displayed expands toward the right side of the drawing sheet, as in the embodiments described earlier. However, while the latest frame alone is displayed in each of the examples presented FIG. 5(a), FIG. 6(a) and FIG. 7(a), a past frame and the latest frame are displayed superimposed one upon the other, as in a sequence of photographs, in the example presented in FIG. 13(b) and FIG. 13(c). It is to be noted that the frames to be superimposed on display may be selected through any method. For instance, frames shot over specific time intervals may be selected, or frames in which a characteristic movement made by the primary subject 200 may be selected.

As the primary subject 200 moves, the block may be controlled so as to move in correspondence to the display range of the primary subject 200. For instance, the primary subject 200 in a display screen 750a shown in FIG. 14(a) may move toward the right side of the screen as in a display screen 750b in FIG. 14(b) and a display screen 750c in FIG. 14(c). Under such circumstances, the block 100a in which the primary subject 200 is displayed moves toward the right side of the drawing sheet. The control unit 70 adds new blocks 100x, 100y and 100z to take up the space vacated by the block 100a on the left side of the drawing sheet. The control unit 70 brings up on display other image data in the new blocks 100x through 100z.

There are cameras known in the related art capable of shooting a video clip and a still image at the same time. For instance, a camera in the known art is capable of capturing a still image while continuously shooting video in response to a specific operation performed while video shooting is in progress or if a specific subject is detected while video shooting is in progress. A pair of a video clip and a still image obtained via such a camera may be displayed in a mode different from that assumed for regular video clips and still images. Such a pair of video image data and still image data may be reproduced as described below in reference to FIG. 15.

In a display screen 740a shown in FIG. 15(a), image data A1, image data C1, image data D1 and image data E1 are individually displayed in four blocks. The image data A1 are video image data. The electronic album data 32 include still image data B1, B2, B3, B4, B5 and B6 obtained while shooting the video image data A1.

As the viewer touches the video image data A1 (as the viewer touches the block in which the video image data A1 are displayed), the control unit 70 starts playing back the video image data A1. As the playback of the video image data A1 progresses to the point at which the still image data B1 were obtained through the shooting operation, the control unit 70 switches from the display screen 740a to a display screen 740b shown in FIG. 15(b). Namely, the control unit 70 adds a new block in the display screen and brings up on display the still image data B1 in the new block. It is to be noted that the still image data B1 may be brought up on display in an existing block without adding a new block.

Likewise, as the playback of the video image data A1 progresses to the point at which the still image data B2 were obtained through the shooting operation, the control unit 70 switches from the display screen 740b to a display screen 740c shown in FIG. 15(c). Namely, the control unit 70 adds a new block in the display screen and brings up on display the still image data B2 in the new block. FIG. 15(d) shows a display screen 740d that will come up after the playback of the video image data A1 progresses to a point past the time point at which the last still image data among the still image data B1 through B6 were obtained through the shooting operation.

It is to be noted that once the size of any block (or the sizes of a predetermined number of blocks) reaches a specific smallest size limit, new blocks are no longer added. In this state, the control unit 70 displays still image data in the blocks where the image data C1, D1 and E1 have been on display, instead of displaying the still image data in newly added blocks. Namely, it removes the image data C1, the image data D1, the image data E1 and the like from the display screen and brings up on display still image data related to the video image data A1 in their place.

It is to be noted that the timing with which video image data playback starts may be set freely. The playback may start in response to a specific viewer operation such as a touch operation as described above, or the playback may automatically start.

The size of the block may be adjusted in correspondence to a change in the luminance of the video image data. For instance, video image data obtained by shooting a video clip of a firework, may be playing in the first block 100a, as shown in FIG. 16(a). As a firework is launched and the luminance of the video image data increases (as the video image becomes brighter), the first block 100a is expanded along the up/down direction and the left/right direction, as shown in FIG. 16(b). Then, as the luminance of the video image data decreases (as the video image becomes darker) following the firework launch, the first block 100a is compressed along the up/down direction and the left/right direction, as shown in FIG. 16(c).

The size of the block may also be adjusted in correspondence to a change in the volume of the audio in the video image data. For instance, video image data obtained by shooting a video clip of a bird may be playing in the first block 100a, as shown in FIG. 17(a). In this case, as the bird crows or sings loudly and the audio volume in the video image data increases, the first block 100a is expanded along the up/down direction and the left/right direction, as shown in FIG. 17(b). At this time, the size of the bird, i.e., the primary subject 200, remains unchanged in the angle of view, unlike in the examples presented in FIG. 9(a) and others. Accordingly, the control unit 70 enlarges a cropped image of the bird and displays the enlarged bird image in the first block 100a. It is to be noted that control may be executed so that the video playback is temporarily paused automatically at the instant at which the volume of the audio is increased.

Another example in which the size of block is adjusted in correspondence to a change in the audio volume in the video image data will be explained below. Video image data obtained by shooting a video clip of an ambulance may be playing in the first block 100a as in the example presented in FIG. 18(a). In this case, as the ambulance moves toward the camera, the size of the first block 100a increases in line with the increase in the size of the ambulance within the angle of view, as has been explained in reference to FIG. 9(a). Assuming that the ambulance is running while sounding its siren, the sound level of the siren, too, increases as the ambulance approaches the camera. Under these circumstances, the synergetic effect of the increase in the size of the ambulance within the angle of view and the increase in the audio volume results in a sudden increase in the size of the first block 100a, as shown in FIG. 18(b). Subsequently as the ambulance moves away, its size within the angle of view and the audio volume of the siren both decrease, and as a result, the size of the first block 100a also becomes smaller, as shown in FIG. 18(c).

The size of the block may also be adjusted in correspondence to the content of the audio data included in the video image data. For instance, video image data obtained by shooting a video clip of a sumo wrestling match may be playing in the first block 100a, as shown in FIG. 19(a). In this case, the control unit 70, recognizing a sound signalling the start of the match in the audio data being played back, expands the first block 100a as shown in FIG. 19(b). Likewise, the control unit 70, recognizing a sound signaling the end of the match in the audio data being played back, compresses the first block 100a to the initial size shown in FIG. 19(a).

The position of a block in which video image data are played back may be determined based upon the content of the video image data. For instance, the control unit 70 may determine that the playback-target video clip features a subject that moves from left to right by analysing the content of the video image data prior to the video image data playback. In such a case, the control unit 70 displays the video image data in a block located on the left side of the display screen. If, on the other hand, the control unit 70 determines that the playback-target video clip features a subject that moves from a point further away from the viewer toward a point closer to the viewer, it displays the video image data in a block located near the centre of the display screen.

Part of the primary subject 200 may be cropped out for playback instead of displaying the entire primary subject 200. For instance, when playing back video image data obtained by shooting a video clip of a wedding ceremony, only an image around a wedding ring may be cropped out for playback during the ring-exchange scene. In addition, a plurality of parts of the primary subject 200 may be cropped out to be played back in different blocks.

As long as the features characterizing the present invention remain intact, the present invention is not limited to the particulars of the embodiments described above, and any other mode conceivable within the scope of the technical teaching of the present invention is within the scope of the present invention.

The embodiments and variations thereof described above include display devices, a display program and a display method described below.

(1) A display device, comprising a display unit at which an image is displayed and a control unit that displays an image in a specific area at the display unit and adjusts the specific area based upon information pertaining to the image.

(2) A display device such as that described in (1) above, in that the control unit adjusts the size of the specific area or the shape of the specific area based upon the information pertaining to the image.

(3) A display device such as that described in (1) or (2) above, in that the control unit adjusts, either continuously or in steps, the size of the specific area or the shape of the specific area based upon the information pertaining to the image.

(4) A display device such as that described in any one of (1) through (3) above, in that the control unit creates an area, which is different from the specific area, at the display unit and displays an image related to the image in the different area based upon the information pertaining to the image.

(5) A display device such as that described in any one of (1) through (4) above, in that the control unit adjusts the position at which the specific area is displayed at the display unit based upon the information pertaining to the image.

(6) A display device such as that described in any one of (1) through (5) above, in that the information pertaining to the image includes an image signal or an audio signal.

(7) A display device such as that described in (6) above, in that the information pertaining to the image includes information related to the composition of the image, detected based upon the image signal.

(8) A display device such as that described in (6) above, in that the information pertaining to the image includes information related to a movement made by, or the size of a primary subject of the image, detected based upon the image signal.

(9) A display device such as that described in (7) above, in that the information pertaining to the image includes information related to the direction of a movement made by a primary subject, detected based upon the image signal, and in which the control unit adjusts the size of the specific area based upon the information related to the direction of the movement made by the primary subject.

(10) A display device such as that described in (9) above, in that the specific area is expanded in the direction along which the primary subject moves.

(11) A display device such as that described in (9) above, in that the position of the specific area is adjusted in the direction along which the primary subject moves.

(12) A display device such as that described in (6) above, in that the information pertaining to the image includes information related to the luminance of a primary subject of the image, detected based upon the image signal.

(13) A display device such as that described in (6) above, in that the information pertaining to the image includes an audio signal obtained while shooting the image.

(14) A display device such as that described in (13) above, in that the control unit adjusts the size of the specific area based upon a change in the audio signal.

(15) A display device such as that described in (13) or (14) above, in that the control unit detects sound made by a primary subject of the image as the audio signal.

(16) A display device such as that described in any one of (1) through (15) above, in that the image displayed by the control unit is a video image.

(17) A display device such as that described in any one of (1) through (15) above, in that the image displayed by the control unit is a plurality of successive still images obtained through a sequence shooting (or serial shooting or successive shooting) operation such as continuous shooting or time-lapse shooting, brought up in sequential display.

(18) A display device such as that described in (16) or (17) above, in that the image is set in an area among a plurality of areas, based upon the information pertaining to the image.

(19) A display device such as that described in (18) above, in that the area in which the image is set is disposed at a position at which a boundary of the area, located in the direction of a change occurring in the composition of the image or in the direction of a change in a movement made by a primary subject of the image, can be moved along the direction of the change.

(20) A display device such as that described in (18) above, further comprising a selection unit that among the plurality of areas that includes at least one area having a boundary that can be moved, selects the image to be set in the area based upon the direction along which the boundary of the area can be moved, and in that the selection unit selects the image with a change in the composition or a change in the movement made by the primary subject of the image occurring along the direction in which the boundary of the area moves.

(21) A display device such as that described in any one of (1) through (20) above, in that as the area in which the image is displayed is adjusted, the control unit also adjusts an area in which another image, different from the image, is displayed.

(22) A display device such as that described in (21) above, in that as the area in which the image is displayed is adjusted, the control unit adjusts at least one factor among the number of areas in which the other images are displayed, the shapes of the areas, the positions of the areas and the sizes of the areas.

(23) A display device such as that described in (22) above, in that once reproduction of the image is completed, a display mode in effect prior to the reproduction is resumed or a display mode in effect at the completion of the reproduction of the image is sustained.

(24) A display device such as that described in (23) above, in that the display mode in effect prior to the reproduction of the image is either the position or the size of an initial area.

(25) A display program that enables a computer to execute a display step in which an image is displayed at a display screen and a control step in which an image is displayed in a specific area at the display screen and the specific area is adjusted based upon information pertaining to the image.

(26) A display method comprising a display step in which an image is displayed at a display screen and a control step in which an image is displayed in a specific area at the display screen and the specific area is adjusted based upon information pertaining to the image.

The disclosure of the following priority application is herein incorporated by reference. Japanese Patent Application No. 2015-234195 filed, Nov. 30, 2015

### REFERENCE SIGNS LIST

1 . . . image reproduction system, 2 . . . network, 3 . . . server, 4 . . . information terminal, 5, 5a, 5b . . . camera, 6a, 6b . . . wireless relay station, 7 . . . portable device, 30 . . . storage device, 70 . . . control unit

1-26. (canceled)

27. A display device, comprising:
a display unit that includes a specific area in which an image is displayed; and
a control unit that, based upon a movement or a sound of a subject in a sequential video image, controls a size or a position of an area where the video image is displayed at the display unit.

28. The display device according to claim 27 wherein:
the control unit controls, either continuously or in steps, the size of the area where the video image is displayed at the display unit based upon the movement or the sound of the subject in the video image.

29. The display device according to claim 27 wherein:
the control unit displays a different area from the specific area at the display unit; and
the control unit displays another video image related to the video image in the different area based upon the subject in the video image.

30. The display device according to claim 29 wherein:
the control unit controls a size of the different area displayed at the display unit based upon the movement of the subject in the video image.

31. The display device according to claim 27, wherein:
the control unit controls so that the specific area is displayed larger at the display unit according to a direction of the movement of the subject in the video image.

32. The display device according to claim 27, wherein:
the control unit controls the position of the specific area displayed at the display unit according to a direction of the movement of the subject in the video image.

33. The display device according to claim 27, wherein:
the control unit controls the size or the position of the specific area displayed at the display unit based upon luminance of the subject in the video image.

34. The display device according to claim 29, wherein:
the control unit controls a size of the different area displayed at the display unit based upon a sound of the video image.

35. The display device according to claim 27, wherein:
the control unit controls so that the specific area is displayed larger at the display unit according to a level of the sound made by the subject of the video image.

36. The display device according to claim 27, wherein:
the control unit controls so that a plurality of successive still images obtained through a sequence shooting operation such as continuous shooting or time-lapse shooting are sequentially displayed at the display unit as the video image.

37. The display device according to claim 27 wherein:
the control unit displays an image in an area different from the specific area at the display unit; and
the control unit controls a size of the different area according to the movement or the sound of the subject in the video image.

38. The display device according to claim 27 wherein:
the control unit controls so that the video image is displayed in the specific area at the display unit and at least one image different from the video image is displayed in an area different from the specific area.

39. The display device according to claim 27, wherein:
the specific area in which the video image is displayed is displayed at a position at which a boundary of the area, located in a direction of a change occurring in a composition of the video image or in a direction of a change in a movement made by a primary subject of the video image, can be moved along the direction of the change.

40. The display device according to claim 27, further comprising:
a selection unit that selects the video image to be displayed in the specific area based upon a direction along which a boundary of the specific area is moved, the boundary of the specific area being able to be moved, wherein:
the selection unit selects the video image with a change in a composition of the video image or a change in a movement made by a primary subject of the video image occurring along the direction in which the boundary of the specific area moves.

41. The display device according to claim 27, wherein:
as the area in which the video image is displayed is adjusted, the control unit also adjusts an area in which another image, different from the video image, is displayed.

42. The display device according to claim 41, wherein:
as the area in which the video image is displayed is adjusted, the control unit adjusts at least one factor among a number of areas in which other images are displayed, shapes of the areas, positions of the areas and sizes of the areas.

43. The display device according to claim 42, wherein:
once reproduction of the video image is completed, a display mode in effect prior to the reproduction is resumed or a display mode in effect at completion of the reproduction of the image is sustained.

44. The display device according to claim 43, wherein:
the display mode in effect prior to the reproduction of the video image is either a position or a size of an initial area.

45. A display program that enables a computer to execute:
a display step of displaying an image in a specific area at a display screen; and
a control step of, based upon a movement or a sound of a subject in a sequential video image, controlling a size or a position of an area of the video image that is displayed at the display screen.

46. A display method, comprising:
a display step of displaying an image is displayed in a specific area at a display screen; and
a control step of, based upon a movement or a sound of a subject in a sequential video image, controlling a size or a position of an area of the video image that is displayed at the display screen.
